(19) United States
(12) Patent Application Publication
(10) Pub. No.: US 2014/0356707 A1
(43) Pub. Date: Dec. 4, 2014

(54) NEGATIVE ELECTRODE ACTIVE MATERIAL FOR RECHARGEABLE LITHIUM BATTERY, METHOD FOR PREPARING THE SAME AND RECHARGEABLE LITHIUM BATTERY INCLUDING THE SAME

(71) Applicant: POSCO CHEMTECH CO., LTD., Pohang-si (KR)

(72) Inventors: Se Mann Kwon, Seoul (KR); Ji Kwon Jung, Cheongju-si (KR); Yong Tae Park, Sejong-si (KR)

(73) Assignee: POSCO CHEMTECH CO., LTD., Pohang-si (KR)

(21) Appl. No.: 14/275,935

(22) Filed: May 13, 2014

(30) Foreign Application Priority Data
May 29, 2013 (KR) 10-2013-0061027

(51) Int. Cl. H01M 4/36; H01M 4/04

(52) U.S. Cl. CPC H01M 4/366; H01M 4/0416
USPC 429/213; 429/231.8; 427/113

(57) ABSTRACT

The present invention relates to a negative electrode active material for a rechargeable lithium battery, a method for preparing the same, and a rechargeable lithium battery including the same. This invention provides a negative electrode active material for a rechargeable lithium battery, comprising a core part including a spherical graphite, and a coating layer containing a low crystalline carbon material and coated on a surface of the core part, wherein a pore volume of less than or equal to 2000 nm is 0.08 ml/g or less, and a tap density is 1.1 g/cm³ or more.

### CROSS-REFERENCE TO RELATED APPLICATION

This application claims priority to and the benefit of Korean Patent Application No. 10-2013-0061027 filed in the Korean Intellectual Property Office on May 29, 2013, the entire contents of which are incorporated herein by reference.

### BACKGROUND OF THE INVENTION

(a) Field of the Invention

The following disclosure relates to a negative electrode active material for a rechargeable lithium battery, a method for preparing the same, and a rechargeable lithium battery including the same.

(b) Description of the Related Art

A rechargeable lithium battery has recently become prominent as a power supply for portable small electronic devices. The rechargeable lithium battery has a discharge voltage of two times higher than an existing battery using an aqueous alkaline solution by using an organic electrolyte solution. As a result, the rechargeable lithium battery provides higher energy density than that of an existing battery.

As a positive electrode active material for the rechargeable lithium battery, an oxide formed of lithium having a structure in which intercalation of lithium ions is possible, such as LiCoO₂, LiMn₂O₄, LiNi₁₋ₓCoₓO₂ (0<x<1), or the like and a transition metal is mainly used.

As a negative electrode material, various types of carbon-based materials including artificial graphite, natural graphite, and hard carbon capable of intercalating/de-intercalating lithium ions have been used. A graphite of the carbon-based has been widely used.

Recently, however, a rechargeable lithium battery having a high capacity has been required due to diversification of a function in a portable small electronic devices and a weight-reduction of a portable small electronic devices. According to that, interest in an active material having a higher theoretical capacity than that of a graphite has been increased.

In particular, a silicone-based metallic material is an active material having 10 times higher theoretical capacity than that of a graphite, so the research on that is being accelerated. However, it has not yet reached the level of commercialization because a performance of a battery is deteriorated resulted from a volume expansion of the silicon particle in the charging process, thereby a decrease in conductivity between active materials, a de-intercalation from an electrode plate, and a continuous reaction of an electrolyte, etc.

In case of a natural graphite, it has a high efficiency as a negative electrode active material due to low price and a similar electrochemical characteristic to an artificial graphite. However, a natural graphite has a large surface area, and its edge surface is completely exposed due to a plate-like shape. Thus, when it applies to a negative electrode active material, a reaction of penetration or decomposition of electrolyte can occur. As a result, the edge surface is peeled off or destroyed, and a non-reversible reaction significantly takes place. In addition, when making an electrode plate, a graphite active material is flatly pressed and oriented on a current collector, so impregnation of the electrolyte solution is not easy and charge-discharge characteristics may be deteriorated.

Therefore, the natural graphite is converted into a smooth surface shape by a post-treatment process such as transforming into spherical shape to reduce an irreversible reaction and to improve a processability of an electrode. Moreover, coating the low-crystalline carbon such as pitch on the surface of the graphite through heat treatment can prevent an exposure of the edge surface, a destruction caused by the electrolyte, and also it can reduce an irreversible reaction. A method of preparing a negative electrode active material by coating a low crystalline carbon to spherical natural graphite is the common way in most manufacturers of negative materials.

However, the negative electrode active material made by the method stated above includes a large amount of pore space inside a graphite particle as a visualization of a natural graphite having flaky particle structure. This pore space makes it difficult to prepare a high-density negative electrode plate by lowering the density of a negative electrode active material. In addition, broken low crystalline carbon coating film resulted from a process for making a high-density of a negative electrode active material on the current collector causes the problem by exposure of the edge surface of graphite.

Therefore, development of a negative electrode active material still having a non-deteriorated characteristic despite making a high-density of negative electrode active material layer on the current collector by preparing a high-density graphite particle resulted from eliminating an internal pore space is needed.

### SUMMARY OF THE INVENTION

An exemplary embodiment of the present invention is to provide a negative electrode active material for a rechargeable lithium battery having an improved cycle-life characteristic by suppressing an irreversible reaction, a method for preparing the same, and a rechargeable lithium battery including the same.

An exemplary embodiment of the present invention provides a negative electrode active material for a rechargeable lithium battery, comprising a core part including a spherical graphite; and a coating layer containing a low crystalline carbon material and coated on a surface of the core part, wherein a pore volume of less than or equal to 2000 nm is 0.08 ml/g or less, and a tap density is 1.1 g/cm³ or more.

A pellet density of the negative electrode active material may be 1.6 g/cm³ or more under 1000 kgf/cm² pressure.

The spherical graphite may be a natural graphite.

The low crystalline carbon material may be petroleum-based pitch, coal-based pitch, mesophase pitch carbonized product, low molecular heavy oil, polyvinyl alcohol (PVA), polyvinyl chloride (PVC), sucrose, calcined coke, or a combination thereof.

An average particle size of the spherical graphite may be 5 to 30 μm.

An average particle size of the low crystalline carbon material may be 1 to 7 μm.

Another exemplary embodiment of the present invention provides a method for preparing a negative electrode active material for a rechargeable lithium battery, comprising mixing a spherical graphite and a low crystalline carbon material; obtaining a composite of the spherical graphite and the low crystalline carbon material by using an isostatic press; and heat-treating the obtained composite.

The mixing a spherical graphite and a low crystalline carbon material may be performed by a mechanical mixing method. The mixing may be performed by a mechanical mixing method.

The mechanical milling method may be performed between 1,000 and 10,000 rpm.

The heat-treating the obtained composite may be performed under an atmosphere of nitrogen, argon, hydrogen, or a mixture gas thereof.

The heat-treating the obtained composite may be performed at a temperature of 700 to 3000° C.

The low crystalline carbon material may be included in 0.1 to 50 parts by weight based on 100 parts by weight of the spherical graphite.

A negative electrode active material for a rechargeable lithium battery comprising a core part including a spherical graphite; and a coating layer containing a low crystalline carbon material and coated on a surface of the core part may be obtained according to the method for preparing a negative electrode active material for a rechargeable lithium battery.

A pore volume of less than or equal to 2000 nm of the obtained negative electrode active material may be 0.08 ml/g or less.

A tap density of the obtained negative electrode active material may be 1.1 g/cm³ or more.

A pellet density of the obtained negative electrode active material may be 1.6 g/cm³ or more under 1000 kgf/cm² pressure.

The spherical graphite may be a natural graphite.

The low crystalline carbon material may be petroleum-based pitch, coal-based pitch, mesophase pitch carbonized product, low molecular heavy oil, polyvinyl alcohol (PVA), polyvinyl chloride (PVC), sucrose, calcined coke, or a combination thereof.

An average particle size of the spherical graphite may be 5 to 30 μm.

Another exemplary embodiment of the present invention provides a rechargeable lithium battery comprising: a negative electrode containing the negative electrode active material for a rechargeable lithium battery according to the above exemplary embodiment of the present invention; a positive electrode containing a positive electrode active material; and an electrolyte.

Specific matters of other exemplary embodiments of the present invention will be included in the detailed description.

According to an exemplary embodiment of the present invention, a rechargeable lithium battery in which a cycle-life characteristic is improved by suppressing an irreversible reaction can be implemented.

### BRIEF DESCRIPTION OF THE DRAWINGS

FIG. 1 is an exploded perspective view of a rechargeable lithium battery according to an exemplary embodiment of the present invention.

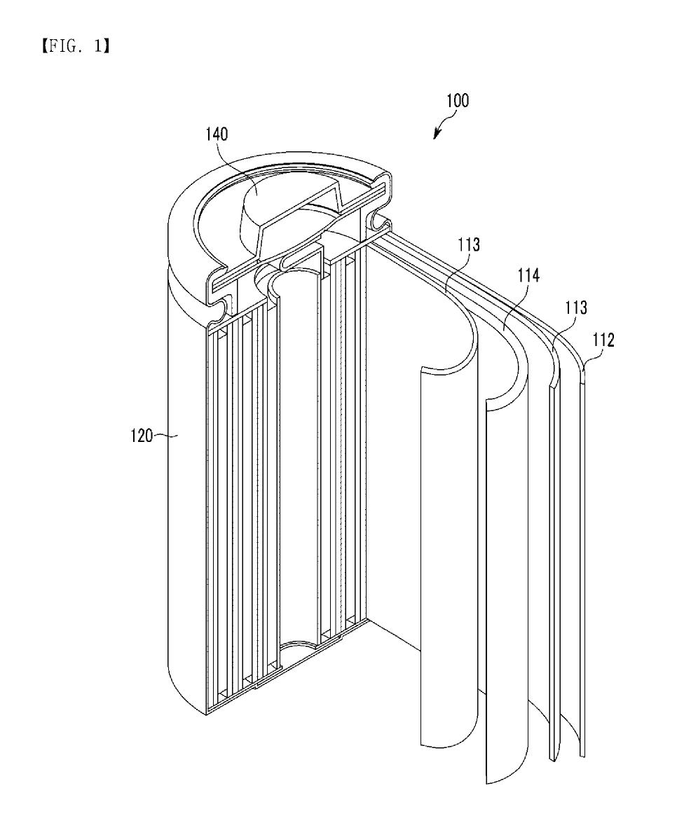

### DETAILED DESCRIPTION OF THE EMBODIMENTS

Hereinafter, embodiments of the present invention will be described in detail. However, the embodiments are described for illustrative purpose, and the present invention is not limited thereto. Therefore, the present invention will be defined by the scope of the appended claims to be described below.

An exemplary embodiment of the present invention provides a negative electrode active material for a rechargeable lithium battery, comprising a core part including a spherical graphite; and a coating layer containing a low crystalline carbon material and coated on a surface of the core part, wherein a pore volume of less than or equal to 2000 nm is 0.08 ml/g or less, and a tap density is 1.1 g/cm³ or more.

The spherical graphite may be a high crystalline spherical graphite. The high crystalline spherical graphite may be obtained by heat-treating a natural graphite. But, it is not limited thereto.

When the above described range of a pore volume and tap density is satisfied, it can improve a solution injection, a minimization of irreversible capacity, and a long cycle-life characteristic of the battery by minimizing a side reaction.

A pellet density of the negative electrode active material may be 1.6 g/cm³ or more under 1000 kgf/cm² pressure. When the above described range of the pellet density is satisfied, it can be obtained a high-density negative electrode active material. In addition, a high-density and an improved solution injection can be satisfied at the same time by the negative electrode active material according to the above exemplary embodiment of the present invention.

The spherical graphite may be a natural graphite, but is not limited thereto.

The low crystalline carbon material may be petroleum-based pitch, coal-based pitch, mesophase pitch carbonized product, low molecular heavy oil, polyvinyl alcohol (PVA), polyvinyl chloride (PVC), sucrose, calcined coke, or a combination thereof, but is not limited thereto.

An average particle size of the spherical graphite may be 5 to 30 μm. In the within the range stated above, a stable negative electrode slurry can be prepared at the time of preparing an electrode, and a high-density electrode can thereby be prepared. Furthermore, in case of a battery using the slurry, a cycle-life characteristic and a safety of the battery can be improved.

An average particle size of the low crystalline carbon material may be 1 to 7 μm. In the within the range, it is possible to uniformly coating a carbon material on a surface of a graphite.

Another embodiment of the present invention provides a method for preparing a negative electrode for a rechargeable lithium battery, comprising mixing a spherical graphite and a low crystalline carbon material; obtaining a composite of the spherical graphite and the low crystalline carbon material by using an isostatic press; and heat-treating the obtained composite.

Alternatively, the method may include obtaining a high crystalline spherical graphite by heat-treatment of the spherical graphite before mixing a spherical graphite and a low crystalline carbon material.

The obtaining a high crystalline spherical graphite by heat-treatment of the spherical graphite may be performed under an inert atmosphere. An inert atmosphere, e.g., may be an argon gas atmosphere.

The obtaining a high crystalline spherical graphite by heat-treatment of the spherical graphite may be performed at a temperature of 2000 to 3000° C. When performed within the temperature range, a high crystalline spherical graphite may be prepared by minimizing defects existing inside a crystallization of a spherical graphite.

The mixing a spherical graphite and a low crystalline carbon material may be performed by a mechanical milling method. A mechanical milling method can mix a spherical graphite and a low crystalline carbon material by selecting any one of the method of ball milling, mechanofusion milling, shaker milling, planetary milling, attritor milling, disk milling, shape milling, nauta mixing (nauta milling), nobilta milling, or a combination of thereof after making the graphite spheroidization.

The mechanical milling method may be performed between 1,000 and 10,000 rpm, but is not limited thereto.

The heat-treating the obtained composite may be performed under an atmosphere of nitrogen, argon, hydrogen, or a mixture gas thereof.

The heat-treating the obtained composite may be performed at a temperature of 700 to 1500° C., specifically, 900 to 1300° C.

An existing natural graphite-based negative material includes heat-treating having an ultra-high-temperature of 2500° C. or more to increase a crystallinity by making a surface of a natural graphite coated with a low crystalline carbon an artificial graphite. However, in the case of preparing a negative electrode plate with a high-density, the ultra-high-temperature heat-treatment causes a decrease in strength during a process of graphitization of a low crystalline carbon. Thus, it has problems such as a solution injection of electrolyte, a de-intercalation of a battery, etc. In particular, it also has a problem that a peeling off occurs on a propylene carbonate electrolyte having characteristics of a low-melting-point, a high-boiling-point, and an excellent conductivity.

Therefore, when performed the heat-treating the obtained composite within the above temperature range, it is possible to maintain a strength and a solution injection during a preparation of a negative electrode plate, and/or to suppress a peeling off of a graphite layer on propylene carbonate (PC) electrolyte by forming a coating layer containing a low crystalline carbon material on a surface of a graphite.

The low crystalline carbon material may be included in 0.1 to 50 parts by weight based on 100 parts by weight of the spherical graphite. When the above described range is satisfied, it is possible to effectively create a coating layer containing a low crystalline carbon material.

Since other related description of the negative electrode active material is the same as previously stated above, the description thereof will be omitted.

Another exemplary embodiment of the present invention provides a method for preparing a negative electrode active material for a rechargeable lithium battery, comprising pressing the spherical graphite by an isostatic press; deagglomerating the isostatically pressed spherical graphite; mixing the deagglomerated spherical graphite and the low crystalline carbon material; and heat-treating the obtained mixture.

The description of the isostatic press is the same as exemplary embodiment of the present invention stated before.

In addition, descriptions of a spherical graphite, a low crystalline carbon material, and heat-treatment are also the same as exemplary embodiment of the present invention stated above.

The deagglomerating the isostatically pressed spherical graphite may be performed by various mechanical methods.

That is, in case of the embodiment of the present invention, it is possible to obtain a similar effect even if a mixing a low crystalline carbon material and a spherical graphite is performed before or after isostatic pressing a spherical graphite.

Pursuant to another embodiment of the present invention, it is possible to provide a rechargeable lithium battery comprising a negative electrode containing the negative electrode active material, a positive electrode containing a positive electrode active material, and an electrolyte. Alternatively, a separator may be present between the negative electrode and the positive electrode.

The rechargeable lithium battery may be classified into a lithium ion battery, a lithium ion polymer battery, and a lithium polymer battery according to a kind of the electrolyte and the separator used therein. Moreover, the lithium battery may have a cylindrical shape, a square shape, a coin shape, a pouch shape, or the like, and it may be a bulk type or a thin film type according to the size. Since the structure of the battery and the method for preparing the same are well known in the art, the detailed description thereof will be omitted.

The negative electrode includes a current collector and a negative electrode active material layer formed thereto, and the negative electrode active material layer contains a negative electrode active material.

The negative electrode active material is the same as previously stated before.

The negative electrode active material layer includes a binder, and may further optionally contain a conductive material.

The binder may serve to join negative electrode active material particles to each other and attach a negative electrode active material to the current collector. As a typical example of the binder, polyvinyl alcohol, carboxy methyl cellulose, hydroxypropyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, polyamide, polyamide imide, styrene-butadiene rubber, acrylated styrene-butadiene rubber, epoxy resin, nylon, or the like may be used, but is not limited thereto.

The conductive material is used in order to give conductivity to the electrode, and may be any material as long as the electronic conductive material does not trigger a chemical change in the battery configured according to the method. For example, a conductive material may contain a carbon-based material such as natural graphite, artificial graphite, carbon black, acetylene black, ketjen black, carbon fiber, or the like; a metal-based material such as a metal powder—copper, nickel, aluminum, sliver, etc., or a metal fiber; a conductive polymer such as polyphenylene derivatives or the like; or a mixture thereof.

As the current collector, a copper thin film, a nickel thin film, a stainless steel thin film, a titanium thin film, a nickel foam, a copper foam, a polymer basic material coated with a conductive metal, or a combination thereof may be used.

The positive electrode includes the current collector and the positive electrode active material layer formed on the current collector.

As the positive electrode active material, a compound (lithiated intercalation compound) capable of reversibly intercalating and de-intercalating lithium ions may be used. In detail, the positive electrode active material may be at least one composite oxide formed of a metal such as cobalt, manganese, nickel, aluminum, iron, magnesium, vanadium, or a combination thereof and the lithium.

The positive electrode active material layer also includes a binder, and a conductive material.

The binder may serve to attach the positive electrode active material particles to each other and attach the positive electrode active material to the current collector. As a typical example, polyvinyl alcohol, carboxy methyl cellulose, hydroxypropyl cellulose, diacetyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, or the like may be used, but is not limited thereto.

The conductive material is used in order to give conductivity to the electrode, and may be any material as long as the electronic conductive material does not trigger a chemical change in the battery configured according to the method. For example, the metal powder such as natural graphite, artificial graphite, carbon black, acetylene black, ketjen black, carbon fiber, copper, nickel, aluminum, silver, or the like, and the metal fiber may be used. In addition, a mixture of one or more conductive materials such as polyphenylene derivatives or the like may be used.

As the current collector, the aluminum (Al) may be used, but the current collector is not limited thereto.

The active material composition is prepared by mixing the active material, the conductive material, and the binding agent with a solvent, and each of the negative electrode and the positive electrode is prepared by applying the composition to the current collector. The method for preparing the electrode as described above is well-known to those skilled in the art. Thus, a detailed description in the specification will be omitted. As the solvent, N-methylpyrrolidone, distilled water or the like may be used, but is not limited thereto.

The electrolyte may include a non-aqueous organic solvent and a lithium salt.

The non-aqueous organic solvent serves as a medium capable of moving the ions concerned in the electrochemical reaction of the battery.

As the non-aqueous organic solvent, a carbonate, an ester, an ether, a ketone, an alcohol, or an aprotic solvent may be used.

The non-aqueous organic solvent may use alone, or in a combination of one or more solvents, and a mixing ratio of the solvent in the case in which the mixture of the one or more solvents is used may be appropriately adjusted according to the desired battery performance. The configuration will be widely understood by those skilled in the art.

The lithium salt dissolves in the non-aqueous organic solvent, so it is possible to operate the basic rechargeable lithium battery by it applying as the lithium ion source within the battery. The lithium salt serves to promote the movement of the lithium ions between the positive electrode and the negative electrode. The lithium salt may include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂) (C_{y}F_{2y+1}SO₂) (herein, x and y are natural numbers), LiCl, LiI, LiB(C₂O₄)₂ (lithium bis (oxalato) borate; LiBOB), or combination thereof, as a supporting electrolytic salt.

The separator 113 serves to electrically isolate the negative electrode 112 and the positive electrode 114 from each other and provide a moving path for the lithium ions. Any separator may be used as long as it is generally used in a lithium battery. That is, a separator having an excellent wetting performance while having a low resistance to ion movement of the electrolyte may be used. For example, the separator may be any one selected from a glass fiber, polyester, Teflon, polyethylene, polypropylene, polytetrafluoroethylene (PTFE), or combinations thereof, and may also be a non-woven or woven fabric type. For example, a polyolefin polymer separator such as polyethylene, polypropylene, or the like is mainly used in the lithium ion battery. Further, a separator coated with a ceramic component or a polymer material in order to secure mechanical strength or heat resistance may be used, and also optionally used in a single-layer or multi-layer structure.

Hereinafter, examples and comparative examples of the present invention will be described. However, this is only one example of the present invention and the present invention is not limited thereto.

### Example 1

### Preparation of Negative Electrode Active Material for a Rechargeable Lithium Battery

Mixing a spherical natural graphite having an average particle size of 16 μm and a binder pitch having a softening point of 250° C. at a weight ratio of 100:4, and homogeneously mixing on the high-speed stirrer at a speed of 2,200 rpm for 10 minutes. Molded body is obtained by isostatically pressing the mixture through Cold Isostatic Press. The molded body is elevated from room temperature to 1,300° C. for 3 hours in an electric furnace after a deagglomeration by using a pin mill, and then the firing is done by keeping it at 1,300° C. for 1.5 hours.

A natural graphite negative active material is prepared by the classification of the graphite composite obtained by the method stated above through 45 μm network.

Used isostatic press and condition are as follows.

Cold isostatic press: KOBELCO CIP Equipment [KOBELCO (CP1300)]

The condition of the press: 100 MPa, 1 minutes

In the example 1, the measurement results of a physical property of a high-density of natural graphite negative electrode active material indicate that its average diameter is 16 μm, tap density is 1.15 g/cm³, specific surface area is 2.2 m²/g.

### Example 2

With respect to an order of the method for preparing, the method is the same as in Example 1, except that a molded body of a spherical natural graphite is obtained by an isostatic press, and then a binder pitch coating is performed after a deagglomeration by using a pin mill.

### (Preparation of Negative Electrode)

The negative electrode active material layer composition is prepared by mixing the negative active material composition and the prepared negative active material, and styrene-butadiene rubber (SBR) as a binder, and carboxymethyl cellulose (CMC) as a thickener at a mass ratio of 98:1:1, and then by dispersing to a distilled water with ions removed.

A negative electrode having electrode density of 1.75±0.05 g/cm³ is prepared by coating the composition to a copper foil current collector, and then by drying and by pressing.

### (Preparation of a Coin Cell)

The negative electrode is used as operation electrode and the metal lithium is used as a counter electrode to prepare a half-cell battery (2032-type coin cell). In this case, a separator made of a porous polypropylene film is inserted between the working electrode and the counter electrode, and an electrolyte solution in which LiPF₆ at a 1 M concentration is dissolved in a mixed solution of diethyl carbonate (DEC) and ethylene carbonate (EC) at a mixing volume ratio of 7:3 are used.

### Comparative Example 1

Molded body is obtained by an isostatic press (Cold Isostatic Press) of a spherical natural graphite having an average particle size of 16 μm. A natural graphite negative active material is prepared by the classification of the molded body through 45 μm network after a deagglomeration by using a pin mill.

In the comparative example 1, the measurement results of the physical property of a high-density natural graphite indicate that its average diameter is 16 μm, tap density is 1.03 g/cm³, specific surface area is 5.2 m²/g.

In addition, a negative electrode and coin cell are prepared by the same method as in Example 1.

### Comparative Example 2

Mixing a spherical natural graphite particle having an average particle size of 16 μm and a binder pitch having a softening point of 250° C. at a weight ratio of 100:4, and homogeneously mixing on the high-speed stirrer at a speed of 2,200 rpm for 10 minutes. The mixture is elevated from room temperature to 1,300° C. for 3 hours in an electric furnace, and then the firing is done by keeping it at 1,300° C. for 1.5 hours.

A natural graphite negative active material is prepared by a classification of the graphite composite obtained by the method stated above through 45 μm network.

In the comparative example 2, the measurement results of the physical property of a spherical natural graphite indicate that its average diameter is 16 μm, tap density is 1.04 g/cm³, specific surface area is 2.9 m³/g.

In addition, a negative electrode and coin cell are prepared by the same method as in Example 1.

### Comparative Example 3

The artificial graphite SCMG-AR made by Showa Denko having an average particle size of 15 μm is used as a negative electrode active material.

In the comparative example 3, the measurement results of the physical property of an artificial graphite indicate that its average diameter is 15 μm, tap density is 1.20 g/cm³, specific surface area is 1.5 m³/g.

In addition, a negative electrode and coin cell are prepared by the same method as in Example 1.

### Evaluation Example

### 1. Measurement of Tap Density

The negative electrode active material according to Example 1, and Comparative Example 1 to 3 is measured by using a tap density meter (Autotap made by Quantachrome), and the results are recorded in Table 1.

The tap density may be measured by using a tap density meter (Autotap made by Quantachrome) after filling with a negative electrode active material 25 g in a 100 ml cylinder and performing a tapping and rotation 3,000 times at the same time.

### 2. Measurement of Pore Volume

The pore volume can be measured by measuring a porosity of less than or equal to 2000 nm through the Mercury Porosimetry (Micromeritics' AutoPore IV 9505) used the principle of measuring porosity based on mercury penetrate.

### 3. Measurement of Specific Surface Area

The specific surface area of a negative electrode active material may be measured by equipment such as Micromeritics' TriSta or Quantachrome's Autosorb-6B.

### 4. Measurement of Pellet Density

A pellet density may be measured by measuring a density after injecting a negative electrode material 1 g to a circular mold having 1 cm diameter and by pressuring under 1000 kgf/cm².

### 5. Measurement of Solution Injection

A pellet per density is prepared by using an active material under the pellet density measurement, thereby evaluating a time when an electrolyte 0.015 g is completely absorbed on a surface of a pellet.

### 6. Evaluation on the Battery Characteristic

### Initial Efficiency

The negative electrode is used as operation electrode and the metal lithium is used as a counter electrode to prepare a half-cell battery (2032-type coin cell). In this case, a separator made of a porous polypropylene film is inserted between the working electrode and the counter electrode, and an electrolyte solution in which LiPF₆ at a 1 M concentration is dissolved in a mixed solution of diethyl carbonate (DEC) and ethylene carbonate (EC) at a mixing volume ratio of 7:3 are used.

The measurement of an initial efficiency is set to 0.01 V (0.01 C) as a cut-off voltage through preparing a half-electrode coin cell. Thereafter, by charging as 0.1 C rate in CC-CV mode and then by discharging to 1.5 V as 0.1 C rate in CC mode, the charge and discharge capacity is measured individually.

### 7. Evaluation on the Battery Characteristic

### Cycle-Life Characteristic

Cycle-life characteristics of each prepared rechargeable lithium battery according to Example 1, and Comparative Example 1 to 3 are evaluated, and the results are recorded in Table 1.

In case of each prepared rechargeable lithium battery according to Example 1 to 4, and Comparative Example 1 to 5, the measurement condition is set to 0.01 V (0.01 C) as a cut-off voltage. Thereafter, after repeating 50 times cycles, charging as 0.5 C rate in CC-CV mode and then discharging to 1.5 V as 0.5 C rate in CC mode, the retention capacity rate is measured.

### 8. Evaluation on the Electrolyte Resistance

### PC Resistance

The negative electrode is used as operation electrode, and the metal lithium is used as a counter electrode to prepare a half-cell battery (2032-type coin cell). In this case, a separator made of a porous polypropylene film is inserted between the working electrode and the counter electrode, and an electrolyte solution in which LiPF₆ at a 1 M concentration is dissolved in a mixed solution of polypropylene carbonate (PC), diethyl carbonate (DEC), and ethylene carbonate (EC) at a mixing volume ratio of 15:60:25 are used. A ratio of an initial charge and discharge capacity is measured.

Table 1 shows results of the evaluation method.

| | | | Compar- | Compar- | Compar- |
|---|---|---|---|---|---|
| | Exam- | Exam- | ative | ative | ative |
| | ple 1 | ple 2 | Example 1 | Example 2 | Example 3 |
| Porosity ¹⁾ (ml/g) | 0.073 | 0.074 | 0.104 | 0.127 | 0.071 |
| Specific surface | 2.2 | 2.1 | 5.2 | 2.9 | 1.5 |
| area (m²/g) | | | | | |
| Tap density | 1.15 | 1.15 | 1.03 | 1.04 | 1.20 |
| (g/cm³) | | | | | |
| Pellet density ²⁾ | 1.68 | 1.67 | 1.82 | 1.58 | 1.43 |
| (g/cm³) | | | | | |
| Solution injec- | 15 | 15 | 45 | 28 | — |
| tion ³⁾ (second) | | | | | |
| Initial efficiency | 94.2 | 94.3 | 92.3 | 93.0 | 92.7 |
| rate ³⁾ (%) | | | | | |
| Cycle-life | 88 | 88 | 57 | 65 | — |
| characteristic ⁴⁾ | | | | | |
| (%) | | | | | |
| PC resistance⁵⁾ | 93.0 | 93.2 | 62.5 | 90.3 | 70.2 |
| (%) | | | | | |

¹⁾ Porosity of 2000 nm or less
²⁾ Pellet denstiy: a density under 1000 kgf/cm² pressure
³⁾ Density of electrode plate: 1.75 ± 0.05 g/cc (in case of Example 3, 1.45 ± 0.05 g/cc)
⁴⁾ Cycle-life characteristic: a half-electrode coin cell Discharge capacity rate before and after 50 times (%) 100 × [(Discharge capacity rate before and after 100 times)/(Discharge capacity rate before and after 1 time)]
⁵⁾PC resistance: Suppression effect of a graphite layer peeling on propylene carbonate (PC) electrolyte

First, pursuant to a value of tap density in Table 1, an apparent density of a negative electrode active material according to Example 1 is higher than that of Comparative Example 1 uncoated by a low crystalline carbon material, Comparative Example 2 non-heat-treated a spherical natural graphite, and Comparative Example 3.

Further, in the case of Example 1, a high-density negative electrode material is prepared having a high tap density and pellet density, and its internal pore volume is smaller than that of Comparative Example 1 isostatically pressed but non-used a binder pitch, and Comparative Example 2 identically prepared to the Example 1 except for an isostatic pressing process. In addition, its specific surface area is small, so it is useful to suppress a side reaction that occur during an initial charge (initial efficiency is inversely proportional to side reaction). In addition, it is helpful for preparing a negative electrode material due to a high injection speed of an electrolyte.

Comparative Example 3 as an artificial graphite is possible to compare with an internal structure of Example 1, but it is difficult to make a high-density due to a high hardness of a particle.

In detail, the most difference between Example 1 and Comparative Example 1 is whether or not there is an ensuring resistance to PC electrolyte (Propylene Carbonate).

A PC electrolyte is difficult to use for a graphite due to a graphite peeling (Exfoliation) caused by Co-intercalation of PC electrolyte around 0.8 V. On the other hand, it can be seen that Example 1 is to secure PC resistance.

The present invention is not limited to the exemplary embodiments, but may be implemented in various different forms. It may be understood by those skilled in the art to which the present invention pertains that the present invention may be implemented with other specific forms without changing the spirit or essential features thereof. Therefore, it should be understood that the above-mentioned embodiments are not restrictive but are exemplary in all aspects.

<Description of symbols>

| | |
|---|---|
| 100: rechargeable lithium battery | 112: negative electrode |
| 113: separator | 114: positive electrode |
| 120: vessel | 140: sealing member |

What is claimed is:

1. A negative electrode active material for a rechargeable lithium battery, comprising:
a core part including a spherical graphite; and
a coating layer containing a low crystalline carbon material and coated on a surface of the core part,
wherein a pore volume of less than or equal to 2000 nm is 0.08 ml/g or less, and
a tap density is 1.1 g/cm³ or more.

2. The negative electrode active material for a rechargeable lithium battery of claim 1, wherein
a pellet density of the negative electrode active material is 1.6 g/cm³ or more under 1000 kgf/cm² pressure.

3. The negative electrode active material for a rechargeable lithium battery of claim 1, wherein
the spherical graphite is a natural graphite.

4. The negative electrode active material for a rechargeable lithium battery of claim 1, wherein
the low crystalline carbon material is petroleum-based pitch, coal-based pitch, mesophase pitch carbonized product, low molecular heavy oil, polyvinyl alcohol (PVA), polyvinyl chloride (PVC), sucrose, calcined coke, or a combination thereof.

5. The negative electrode active material for a rechargeable lithium battery of claim 1, wherein
an average particle size of the spherical graphite is 5 to 30 μm.

6. The negative electrode active material for a rechargeable lithium battery of claim 1, wherein
an average particle size of the low crystalline carbon material is 1 to 7 μm.

7. A method for preparing a negative electrode active material for a rechargeable lithium battery, comprising:
mixing a spherical graphite and a low crystalline carbon material;
obtaining a composite of the spherical graphite and the low crystalline carbon material by using an isostatic press; and
heat-treating the obtained composite.

8. The method of claim 7, wherein
the mixing a spherical graphite and a low crystalline carbon material is performed by a mechanical milling method.

9. The method of claim 8, wherein
the mechanical milling method is performed between 1,000 and 10,000 rpm.

10. The method of claim 7, wherein
the heat-treating of the obtained composite is performed under an atmosphere of nitrogen, argon, hydrogen, or a mixture gas thereof.

11. The method of claim 7, wherein
the heat-treating of the obtained composite is performed at a temperature of 700 to 3,000° C.

12. The method of claim 7, wherein
the low crystalline carbon material is included in 0.1 to 50 parts by weight based on 100 parts by weight of the spherical graphite.

13. The method of claim 7, comprising
obtaining a negative electrode active material for a rechargeable lithium battery comprising
a core part including a spherical graphite; and a coating layer containing a low crystalline carbon material and coated on a surface of the core part.

14. The method of claim 13, wherein
a pore volume of less than or equal to 2000 nm of the obtained negative electrode active material for a rechargeable lithium battery is 0.08 ml/g or less.

15. The method of claim 13, wherein
a tap density of the obtained negative electrode active material for a rechargeable lithium battery is 1.1 g/cm³ or more.

16. The method of claim 13, wherein
a pellet density of the obtained negative electrode active material for a rechargeable lithium battery is 1.6 g/cm³ or more under 1000 kgf/cm² pressure.

17. The method of claim 7, wherein
the spherical graphite is a natural graphite.

18. The method of claim 7, wherein
the low crystalline carbon material is petroleum-based pitch, coal-based pitch, mesophase pitch carbonized product, low molecular heavy oil, polyvinyl alcohol (PVA), polyvinyl chloride (PVC), sucrose, calcined coke, or a combination thereof.

19. The method of claim 7, wherein
an average particle size of the spherical graphite is 5 to 30 to 30 μm.

20. A method for preparing a negative electrode active material for a rechargeable lithium battery, comprising:
pressing the spherical graphite by an isostatic press;
deagglomerating the isostatically pressed spherical graphite;
mixing the deagglomerated spherical graphite and the low crystalline carbon material; and
heat-treating the obtained mixture.

21. A rechargeable lithium battery comprising: a negative electrode containing the negative electrode active material for a rechargeable lithium battery of the claim 1;
a positive electrode containing a positive electrode active material;
and
an electrolyte.
